(19) United States
(12) Patent Application Publication
(10) Pub. No.: US 2026/0045087 A1
(43) Pub. Date: Feb. 12, 2026

(54) CONTENT GENERATION FROM SOURCE MEDIA CONTENT

(71) Applicants: RAVI RAMAMURTHY, Bangalore (IN); RASHMI AIYAPPA, Bangalore (IN)

(72) Inventors: RAVI RAMAMURTHY, Bangalore (IN); RASHMI AIYAPPA, Bangalore (IN)

(21) Appl. No.: 19/008,696

(22) Filed: Jan. 3, 2025

(30) Foreign Application Priority Data
Aug. 8, 2024 (IN) 202441059976

(51) Int. Cl. G06V 20/40; G06Q 10/10; G06T 7/70; G06V 10/70; G06V 30/10

(52) U.S. Cl. CPC G06V 20/46; G06Q 10/103; G06T 7/70; G06V 10/70; G06V 30/10; G06T 2207/10016

(57) ABSTRACT

A computer-implemented method for generating content from video is described. In an example, video content may be extracted from source media that includes captured process steps involving a business process performed via an application. Further, time-aligned video frames may be extracted from the video content. Each frame represents an image at a different time. Furthermore, the time-aligned video frames may be processed to extract control data representing the captured process steps related to the business process. Based on the extracted control data, the content may be generated in a desired format to perform the business process.

### RELATED APPLICATIONS

Benefit is claimed under 35 U.S.C. 119(a)-(d) to Foreign Application Serial No. 202441059976 filed in India entitled “CONTENT GENERATION FROM SOURCE MEDIA CONTENT”, on Aug. 8, 2024, by RAVI RAMAMURTHY and RASHMI AIYAPPA, which is herein incorporated in its entirety by reference for all purposes

### TECHNICAL FIELD

The present disclosure relates to methods, techniques, and systems for generating content from source media that includes video.

### BACKGROUND

In today's competitive business landscape, organizations frequently implement new enterprise applications or upgrade existing ones to stay ahead. This dynamic environment necessitates knowledge transfer initiatives to ensure users can effectively utilize these applications. Knowledge transfer encompasses capturing essential information and delivering it to end users in several ways. Organizations may choose to facilitate in-person training, where subject matter experts (SMEs) may be deployed to various user locations to provide hands-on training. In other examples, organizations may choose to develop digital resources, where knowledge may be captured through written instructions, interactive guides, or online training modules. In some other examples, organizations may choose to document processes, in which key process steps may be stored in detailed video formats.

For example, the initial project phase involves collaboration between the client and service providers (e.g., outsourcing companies) to define the project scope. This includes assessing requirements, objectives, and overall work involved. During this stage, the client and service providers may identify specific processes for outsourcing and establish project goals. A detailed plan is then created, outlining timelines, milestones, resource needs, potential risks, and corresponding backup plans. Online meetings facilitate further collaboration. The client's Subject Matter Expert (SME) may demonstrate key processes by recording themselves performing the tasks according to the agreed-upon plan. These recordings are then shared with the service provider to provide a clear understanding of the work involved.

The service provider leverages these recordings to create comprehensive documents that detail the processes, workflows, and Standard Operating Procedures (SOPs). These documents become valuable training materials for future users. However, manually converting the video recordings into detailed documents can be time-consuming. Additionally, extracting implicit knowledge (e.g., tacit knowledge) embedded within the SME's actions and explanations during the recordings can be challenging.

### BRIEF DESCRIPTION OF THE DRAWINGS

FIG. 1 is a block diagram of an example system, depicting a content generation module to generate content in a desired format based on processing time-aligned video frames;

FIG. 2 is a block diagram of the example system of FIG. 1, depicting additional features of the content generation module;

FIG. 3A is a flow diagram illustrating an example method for generating content in a desired format from video content of source media;

FIG. 3B is a flow diagram illustrating an example method for generating content in a desired format from video content and audio content of source media;

FIG. 4 is a flow diagram illustrating an example method for generating a process file from a subject matter expert (SME) multimedia content;

FIG. 5 is a flow diagram illustrating an example method for processing time-aligned video frames of the multimedia content using a trained machine learning model to determine control regions;

FIG. 6 is a flow diagram illustrating an example method for processing time-aligned video frames of the multimedia content to extract control data representing captured process steps related to a business process;

FIG. 7 is a flow diagram illustrating an example method for generating a process file by converting audio content of the multimedia content to text; and

FIG. 8 is a block diagram of an example computing device including non-transitory computer-readable storage medium storing instructions to generate content in a desired format from source media including video content.

The drawings described herein are for illustrative purposes and are not intended to limit the scope of the present subject matter in any way.

### DETAILED DESCRIPTION

Examples described herein may provide an enhanced computer-based method, technique, and system to generate content in a desired format based on processing source media including video content and audio content. The paragraphs [0017] and [0018] present an overview of the content generation, existing methods to generate the content, and drawbacks associated with the existing methods.

Content for software applications can encompass various materials, such as training manuals, presentations, performance aids, testing tools, and quality assurance resources. Training materials themselves can include user guides, help files, videos, animations, and so on. Creating content for software applications can be a time-consuming task. Traditional approaches often involve collaboration between content developers (e.g., writers) and software developers. The content developer needs to understand the software thoroughly to create accurate training materials. While authoring and content development tools can streamline the process to some extent by reducing manual effort, they often involve repetitive tasks. Additionally, content may need to be adapted for different languages, user expertise levels, visual styles, output formats, and so on. These factors can significantly increase the overall time required for content creation.

In some examples, organizations can leverage video recordings for knowledge transfer. In this example, subject matter experts (SMEs) can demonstrate business processes while being recorded. These video tutorials may provide step-by-step instructions for training or reference. In another example, the recording may focus on capturing the SME performing the actual process. This allows for later analysis to identify best practices, bottlenecks, or areas for improvement. These recordings are then converted into comprehensive documents detailing processes, workflows, and Standard Operating Procedures (SOPs). However, this conversion process can be time-consuming as the process involves information extraction, structuring, writing, editing, and so on.

Examples described herein may provide a computer-implemented method for generating content (e.g., a process document) from recorded SME videos. In an example, audio content and video content may be extracted from source media including captured process steps involving a business process performed via an application. Further, time-aligned video frames may be extracted from the video content. Each frame may represent an image at a different time. Furthermore, the time-aligned video frames may be processed to extract control data representing the captured process steps related to the business process. Also, context information/intent for the audio content may be generated based on the time-aligned video frames. Further, the audio content may be converted into text by using the context information. Then, the content may be generated in the desired format based on the extracted control data and the text obtained by converting the audio content.

Thus, the recorded SME videos are transformed into comprehensive process documents. These documents include detailed written instructions outlining the processes, workflows, and Standard Operating Procedures (SOPs). The process documents provide instructions for users, making them valuable training materials. Users can refer to these documents for guidance whenever needed, ensuring consistent process execution. Also, the process documents can be used to generate a simulated process to perform the business process. The ability to publish these documents in individual screens (e.g., focusing on specific steps) or consolidated formats (e.g., complete overview) caters to different user preferences and learning styles. Users can access the information in a way that best suits their needs, whether it is a quick reference or a detailed walkthrough.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

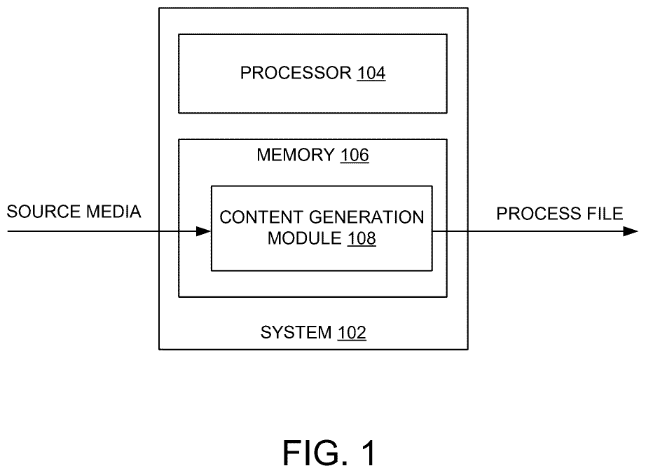

Referring now to the figures, FIG. 1 is a block diagram of an example system 102, depicting content generation module 108 to generate content in a desired format based on processing time-aligned video frames. Example system 102 may include a computing device such as, but are not limited to, portable, mobile, or other devices such as mobile phones (including smartphones), laptop computers, desktop computers, tablet computers, server computers, mainframes, and the like.

System 102 includes a processor 104 and a memory 106 that is communicatively coupled to processor 104. Memory 106 includes content generation module 108. During operation, content generation module 108 can process source media, such as a video file, by first converting the source media into individual video frames. The video frames are then processed using a machine learning model, such as a deep convolutional neural network (DCNN). From the processed frames, content generation module 108 can extract control coordinates for a specific object within each video frame. These control coordinates may represent control data. Using the extracted control coordinates, content generation module 108 can retrieve the corresponding control data and store the retrieved control data in a process file.

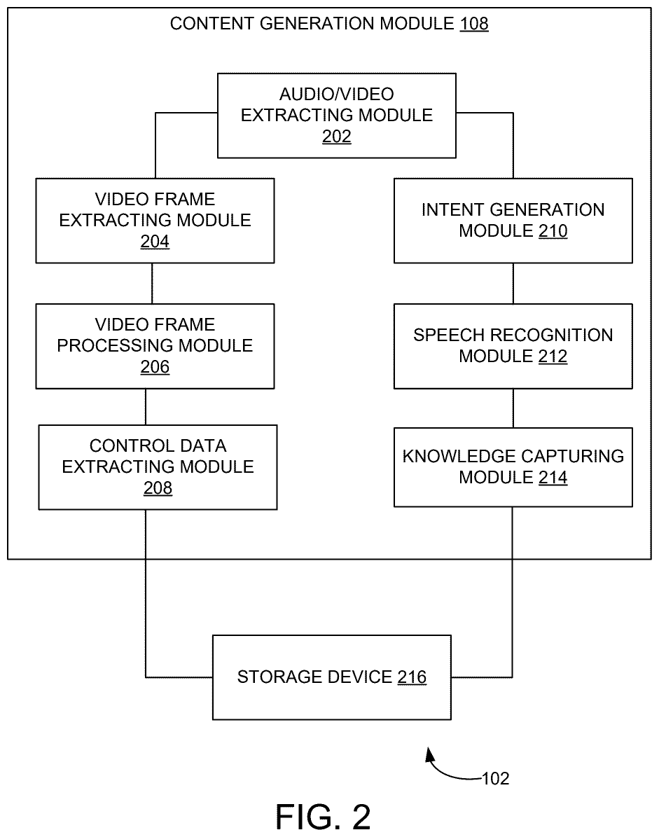

Further, content generation module 108 may use automatic speech recognition (ASR) software to convert spoken audio in the source media into text. Once the audio is converted to text, content generation module 108 may generate context information based on the text. The context information considered as tacit knowledge, can be understood by the end user based on the context associated with the control data or the video frames. Further, content generation module 108 may store the converted text and/or the generated context information in the process file. The process file including the control data and the generated context information can be used to create the standard documents and interactive simulations. The structure and/or function of content generation module 108 is explained in detail using FIG. 2.

FIG. 2 is a block diagram of example system 102 of FIG. 1, depicting additional features of content generation module 108. As shown in FIG. 2, content generation module 108 includes audio/video extracting module 202, video frame extracting module 204, video frame processing module 206, control data extracting module 208, intent generation module 210, speech recognition module 212, and knowledge capturing module 214. Also, system 102 includes a storage device 216.

During operation, audio/video extracting module 202 may extract video content from source media that includes captured process steps involving a business process performed via an application.

Further, video frame extracting module 204 may extract time-aligned video frames from the video content. Each frame may represent an image at a different time. For example, the video content includes a series of still images shown in a sequence, creating an illusion of motion. Each individual image is called a video frame. In this example, extracting time-aligned video frames refers to fetching still images (i.e., video frames) from the video content at specific points in time, and ensuring the video frames correspond to each other.

Video frame processing module 206 may process the time-aligned video frames. Upon processing the time-aligned video frames, control data extracting module 208 may extract control data representing the captured process steps related to the business process.

In an example, video frame processing module 206 may analyze successive frames of the time-aligned video frames to extract the control data. In this example, video frame processing module 206 may detect for each frame a change in a current frame relative to a previous frame. Further, video frame processing module 206 may determine coordinates corresponding to the detected change in the current frame. Furthermore, control data extracting module 208 may extract the control data from the current frame based on the determined coordinates.

In another example, control data extracting module 208 may extract the control data from each frame of the time-aligned video frames based on a position of a mouse cursor. In this example, video frame processing module 206 may identify a position of a mouse cursor indicating a current point of user interaction within a current frame of the time-aligned video frames. Further, video frame processing module 206 may determine coordinates corresponding to the position of the mouse cursor in the current frame. Furthermore, control data extracting module 208 may extract the control data from the current frame based on the determined coordinates.

In yet another example, control data extracting module 208 may extract the control data from each frame of the time-aligned video frames based on a caret position. In this example, video frame processing module 206 may identify a caret position indicating a text insertion point within a current frame of the time-aligned video frames. Further, video frame processing module 206 may determine coordinates corresponding to the caret position in the current frame. Furthermore, control data extracting module 208 may extract the control data from the current frame based on the determined coordinates.

In yet another example, control data extracting module 208 may extract the control data from each frame of the time-aligned video frames based on border detection. In this example, video frame processing module 206 may detect a border of a graphical user interface (GUI) element within a current frame of the time-aligned video frames. Further, video frame processing module 206 may determine coordinates corresponding to the GUI element in the current frame based on the detected border. Furthermore, control data extracting module 208 may extract the control data from the current frame based on the determined coordinates.

Thus, examples described herein may identify and extract specific control data, such as text, numbers, symbols, or any other relevant information embedded within the video frames. Further, control data extracting module 208 may store the control data in storage device 216. Based on the extracted control data, content generation module 108 may generate content in a desired format to perform the business process.

Further, audio/video extracting module 202 may extract audio content from the source media. Intent generation module 210 may generate context information/intent for the audio content based on the time-aligned video frames. In this example, the context information/intent is used to analyse time-aligned video frames and audio together to unlock a deeper understanding of the content. Furthermore, speech recognition module 212 may convert the audio content into text by using the context information. Furthermore, knowledge capturing module 214 may store the text as the tacit knowledge in storage device 216. In this example, content generation module 108 may generate the content in the desired format based on the extracted control data and the text obtained by converting the audio content.

In some examples, the generated content can be used to generate a simulated process to perform the business process. In this example, content generation module 108 may create a simulated business process to perform the process steps involving the business process based on the generated content. The simulated business process may include at least one of:
a show mode to demonstrate the simulation without user interaction,
a guide mode to provide a step-by-step guidance as a user interacts with the simulated business process, and
a test mode to assess the user's understanding or proficiency with the simulated business process.

In some examples, the functionalities described in FIGS. 1 and 2, in relation to instructions to implement functions of content generation module 108, audio/video extracting module 202, video frame extracting module 204, video frame processing module 206, control data extracting module 208, intent generation module 210, speech recognition module 212, knowledge capturing module 214, and any additional instructions described herein in relation to the storage medium, may be implemented as engines or modules including any combination of hardware and programming to implement the functionalities of the modules or engines described herein. The functions of content generation module 108, audio/video extracting module 202, video frame extracting module 204, video frame processing module 206, control data extracting module 208, intent generation module 210, speech recognition module 212, and knowledge capturing module 214 may also be implemented by processor 104. In examples described herein, processor 104 may include, for example, one processor or multiple processors included in a single device or distributed across multiple devices.

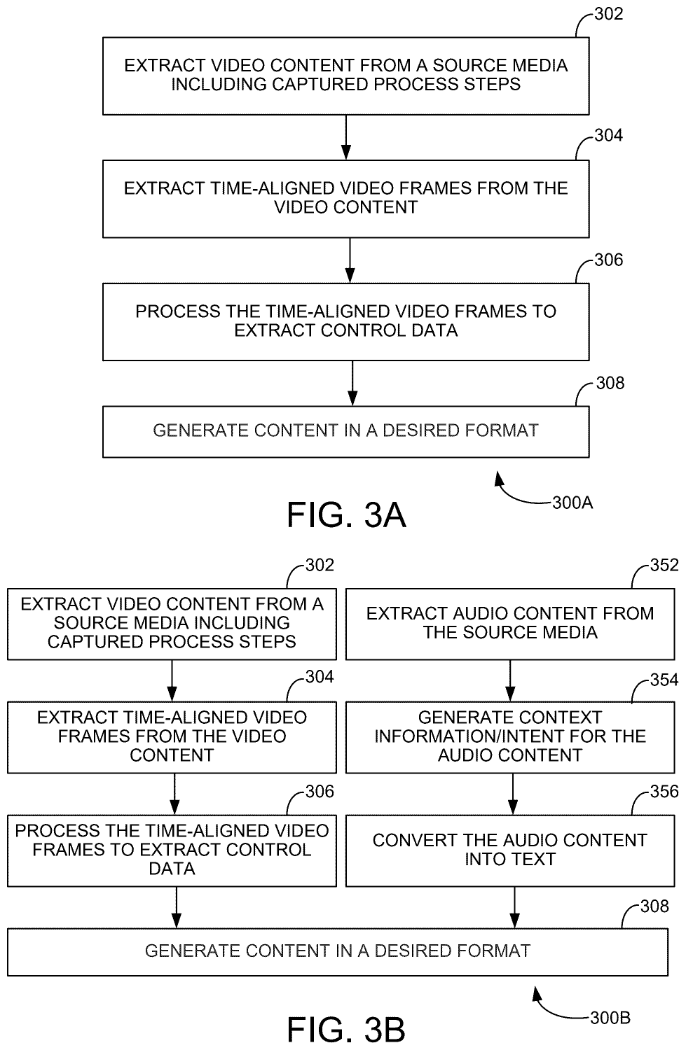

FIG. 3A is a flow diagram illustrating an example method 300A for generating content in a desired format from video content of source media. Example method 300A depicted in FIG. 3A represents generalized illustrations, and other processes may be added, or existing processes may be removed, modified, or rearranged without departing from the scope and spirit of the present application. In addition, method 300A may represent instructions stored on a computer-readable storage medium that, when executed, may cause a processor to respond, to perform actions, to change states, and/or to make decisions. Alternatively, method 300A may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 302, video content is extracted from source media that includes captured process steps involving a business process performed via an application. In an example, the time-aligned video frames are extracted from the video content at a specific frame rate. At 304, time-aligned video frames are extracted from the video content, each frame representing an image at a different time.

At 306, the time-aligned video frames may be processed to extract control data representing the captured process steps related to the business process. In an example, the time-aligned video frames may be processed by removing redundant frames that are identical or similar from the time-aligned video frames. Upon removing the redundant frames, filtering, refining, fusing, and/or normalizing the time-aligned video frames may be performed. For example, the time-aligned video frames may be filtered to remove unwanted data from the time-aligned video frames. The time-aligned video frames may be refined to enhance quality of information within the time-aligned video frames. The time-aligned video frames may be fused to leverage data from different frames to enhance the quality of information. The time-aligned video frames may be normalized to scale pixel values within each frame of the time-aligned video frames to a specific range.

Further, the control data representing the captured process steps can be extracted from the processed video frames. In an example, processing the time-aligned video frames may include generating respective optical character recognition (OCR) data associated with the time-aligned video frames and extracting, based at least in part on the respective OCR data, the control data representing the captured process steps associated with the time-aligned video frames.

In an example, processing the time-aligned video frames may include processing the time-aligned video frames using a trained machine learning model to extract the control data representing the captured process steps related to the business process. As the trained machine learning model processes each video frame, the trained machine learning model can recognize and extract the control data using different methods as follows.

In an example, processing the time-aligned video frames includes analyzing successive frames of the time-aligned video frames to extract the control data. In this example, analyzing the successive frames includes:
for each frame,
   detecting a change in a current frame relative to a previous frame,
   determining coordinates corresponding to the detected change in the current frame, and
   extracting the control data from the current frame based on the determined coordinates.

In another example, processing the time-aligned video frames includes:
for each frame of the time-aligned video frames,
   identifying a position of a mouse cursor indicating a current point of user interaction within a current frame of the time-aligned video frames,
   determining coordinates corresponding to the position of the mouse cursor in the current frame, and
   extracting the control data from the current frame based on the determined coordinates.

In yet another example, processing the time-aligned video frames includes:
for each frame of the time-aligned video frames,
   identifying a caret position indicating a text insertion point within a current frame of the time-aligned video frames,
   determining coordinates corresponding to the caret position in the current frame, and
   extracting the control data from the current frame based on the determined coordinates.

In yet another example, processing the time-aligned video frames includes:
for each frame of the time-aligned video frames,
   detecting a border of a graphical user interface (GUI) element within a current frame of the time-aligned video frames,
   determining coordinates corresponding to the GUI element in the current frame based on the detected border, and
   extracting the control data from the current frame based on the determined coordinates.

At 308, content is generated in a desired format to perform the business process based on the extracted control data. Further, a simulated business process to perform the process steps involving the business process can be created based on the generated content.

FIG. 3B is a flow diagram illustrating an example method 300B for generating content in a desired format from video content and audio content of the source media. For example, similarly named elements of FIG. 3B may be similar in structure and/or function to elements described in FIG. 3A.

At 352, audio content may be extracted from the source media. At 354, context information/intent for the audio content may be generated based on the time-aligned video frames. At 356, the audio content may be converted into text by using the context information. In the example shown in FIG. 3B, at 308, the content may be generated in the desired format based on the extracted control data and the text obtained by converting the audio content.

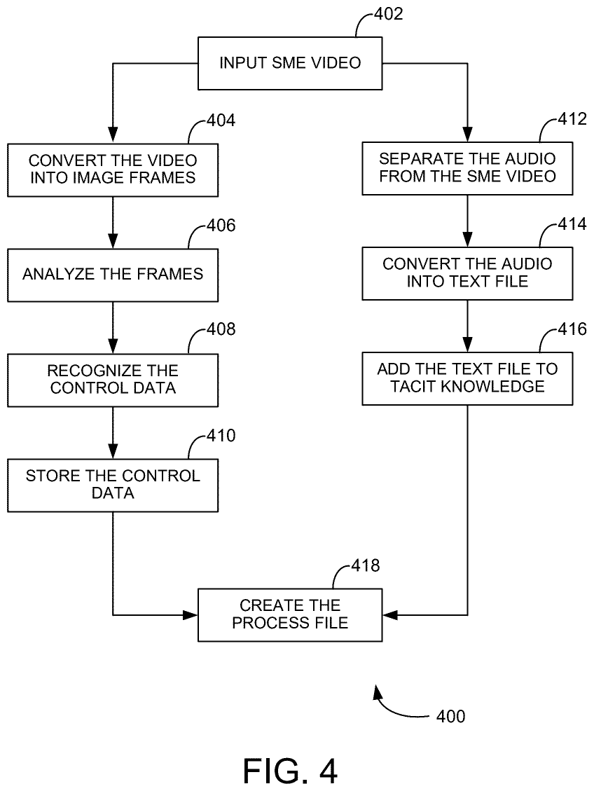

FIG. 4 is a flow diagram illustrating an example method 400 for generating a process file from a subject matter expert (SME) multimedia content. At 402, Subject Matter Expert (SME) multimedia content can be inputted into a content generation module, as shown in FIG. 1. At 404, the SME multimedia content can be converted into video frames. In an example, a video file can be processed to extract individual images, called frames. These frames are captured at a specific rate, typically 24 frames per second. Each frame captures a still image from the video at a specific moment in time.

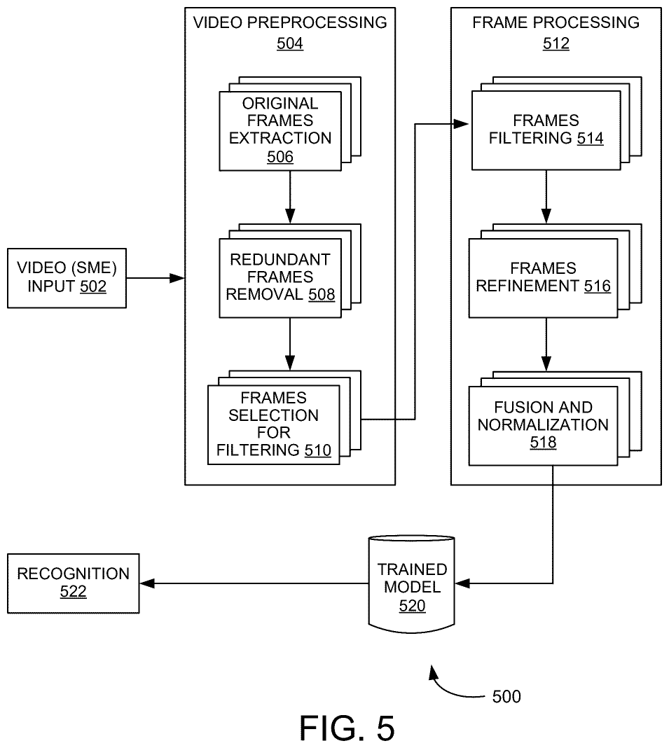

At 406, the video frames are processed or analyzed, for example, using a convolutional neural network (CNN) such as the You Only Look Once (YOLO) algorithm. An example of video frame processing is explained in FIG. 5. At 408, control data may be determined or recognized from the processed video frames. In one example, control coordinates are first extracted from these processed frames. Then, using the control coordinates, the control data can be determined.

In an example, each video frame extracted from the video content undergoes OCR (Optical Character Recognition) processing. This technology analyzes the text within each frame, aiming to identify and extract specific control data from the interacted screens. This control data can include text, numbers, symbols, or any other relevant information embedded within the frames. This control data is then used to generate sentences and map the corresponding control regions. Finally, a capture file that associates this information can be generated.

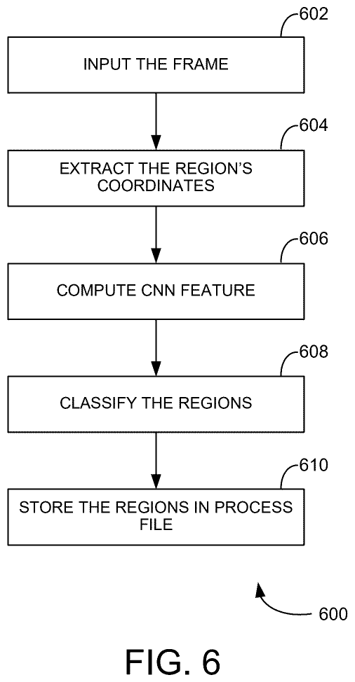

In some examples, the video frames are processed using a trained machine learning model to extract the control data. As the trained machine learning model processes each image, the model recognizes and extracts the control data the model identifies. This control data is used for understanding user interaction within a Graphical User Interface (GUI). Below are some control data points that the model focuses on:
Mouse Cursor Location: Identifying a position of a mouse cursor within an image in GUI applications. It signifies the current point of user interaction.
Caret Position: The caret position, represented by the blinking vertical bar in editable text fields, indicates where text input will occur.
Highlighted Borders: Detecting borders assist in identifying the currently focused control within the GUI.
Changes Between Frames: By analyzing the differences between previous and current frames, the model can detect changes in the GUI, such as cursor movements, alterations in highlighted controls, or shifts in caret positions. This comparison aids in tracking user interactions and pinpointing the control region or area of interest. The identified information can also include timestamps, codes, labels, instructions, or any other form of actionable information embedded within the images. An example data extraction is explained in FIG. 6.

At 410, the control data may be stored. In an example, the recognized control data from each frame is compiled and stored in a structured format, for instance, as a file such as a text file or a structured data file (e.g., JSON, CSV, or the like).

At 412, the audio content may be separated from the SME multimedia content. At 414, the audio content may be converted into text file. At 416, the text file may be added to tacit knowledge. At 418, the process file is created using the text file that includes the control data and the text file obtained by converting the audio content. In an example, the data file is processed to generate a process file in a specific format required by a particular process or system. The process file can then be used to create standard documents and interactive simulations.

FIG. 5 is a flow diagram illustrating an example method 500 for processing time-aligned video frames of the multimedia content (e.g., SME video) using a trained machine learning model to determine control regions. At 502, the SME video is provided as input to the system. At 504, the SME video may be preprocessed to extract the video frames (e.g., at 506), remove the redundant frames (e.g., at 508), and select the frames for processing (e.g., at 510). At 506, the SME multimedia content can be converted into video frames. At 508, video frames that contain minimal or no change compared to the frames before or after them may be identified and eliminated to reduce the overall file size of the video frames. At 510, specific frames are selected from the extracted video frames to be used with a particular filtering process.

At 512, the selected frames are processed. Processing the selected frames may include filtering (e.g., at 514), refinement (e.g., at 516), fusion and normalization (e.g., at 518). At 514, the selected video frames are filtered to remove unwanted data from the selected video frames. For example, this step may involve applying specific algorithms to modify the visual characteristics of a frame. Examples include noise reduction, color correction, sharpening, special effects, and the like. At 516, the filtered video frames are refined to enhance quality of information within the video frames. Refining the video frames may enhance aspects like clarity, detail, or object segmentation. Techniques such as edge detection or object boundary refinement can be used for this purpose.

At 518, the refined video frames are fused to leverage data from different frames to enhance the quality of information. In this example, information from multiple video frames may be combined to create a new, enhanced frame. This process aims to leverage the strengths of different frames to improve the overall quality of information extracted from the video. Further at 518, the video frames are normalized to scale pixel values within each video frame to a specific range. The normalization may ensure consistency across the video frames.

At 522, a trained machine learning model 520 is applied to the processed frames to recognize control regions of the frames. The control regions may refer to specific elements on a screen that a user can click, tap, type in, or otherwise engage with to control an application or website.

FIG. 6 is a flow diagram illustrating an example method 600 for processing time-aligned video frames of the multimedia content to extract control data representing captured process steps related to a business process. Once the control regions are recognized in the video frames (e.g., as described in FIG. 5), the video frames may be provided as input (e.g., at 602) to extract coordinates of the control regions, at 604. The coordinates may define locations of the control regions within the frame. The coordinates may be in the form of bounding boxes (e.g., specifying top-left and bottom-right corners) or other formats depending on the chosen representation.

At 606, a CNN feature may be computed for the control regions. In this example, a specific representation of the identified control regions may be extracted using the CNN. The representation may capture the essential visual characteristics of the control regions that are relevant for classification. For example, the CNN processes the control regions through its layers, extracting features like edges, shapes, colors, textures, and other characteristics that are important for classification.

At 608, the control regions may be classified using the CNN feature. In this example, a CNN model may be used to analyze the CNN features (e.g., visual characteristics) extracted from each identified control region. Further, the CNN model may categorize the control regions based on the CNN features. For example, the classification may involve recognizing specific objects (e.g., buttons, text boxes, and the like), identifying UI elements with specific functionalities, or performing any other relevant classification task, depending on a type of the application.

At 610, the control data associated with the classified control regions may be stored in a process file. In an example, the extracted information, including the region's coordinates and its classification based on the CNN features, is considered control data. This data is stored in the process file. The control data may refer to interactive components that a user interacts with in a user interface, such as buttons, text fields, drop-down menus, sliders, and the like.

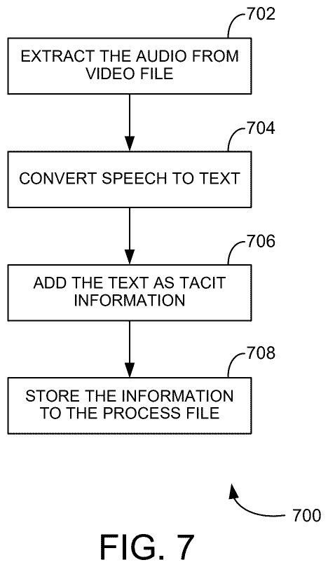

FIG. 7 is a flow diagram illustrating an example method 700 for generating a process file by converting audio content of the multimedia content to text. At 702, the audio content from the SME video may be extracted. To extract the audio content from the input SME video file, various tools such as Fast Forward MPEG (FFMPEG) can be used.

At 704, the audio content may be converted to text. In an example, an Automatic Speech Recognition (ASR) software can be used to convert speech to text. This software employs algorithms to process audio and recognize spoken words, converting them into written text. In some example scenarios, manual editing may be employed to ensure accuracy.

At 706, the text may be added as a tacit information. Once the audio content is converted to text, the tacit information may be generated from the converted text. This information may act as the tacit knowledge for the end users. For example, the converted text can be overlaid onto video frames to provide explicit information or labels for the end users. Adding text overlays can enhance viewers'understanding of the control data or the video frames by providing clear explanations or labels. At 708, the information may be stored to the process file. The tacit information is stored in the process file and will be used to generate the documents and simulations.

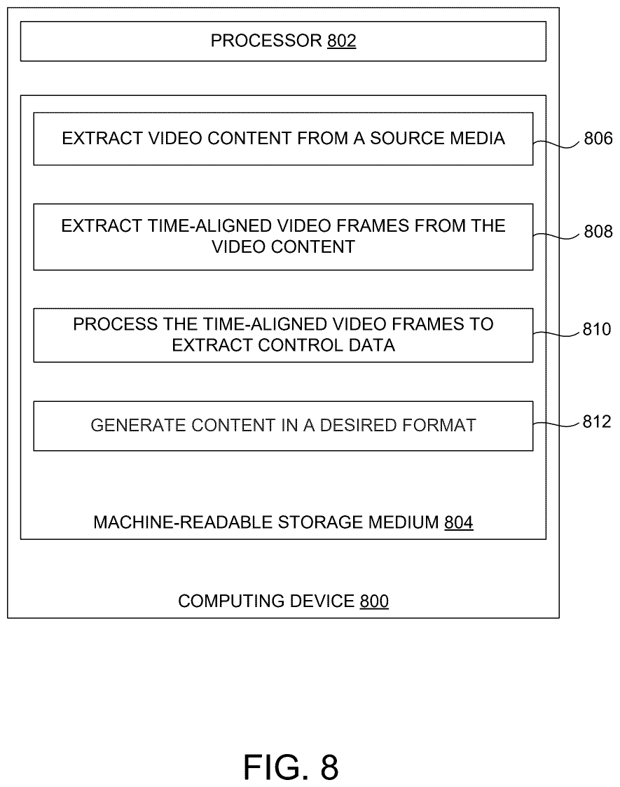

FIG. 8 is a block diagram of an example computing device 800 including non-transitory computer-readable storage medium storing instructions to generate content in a desired format from source media including video content. Computing device 800 may include a processor 802 and computer-readable storage medium 804 communicatively coupled through a system bus. Processor 802 may be any type of central processing unit (CPU), microprocessor, or processing logic that interprets and executes computer-readable instructions stored in computer-readable storage medium 804. Computer-readable storage medium 804 may be a random-access memory (RAM) or another type of dynamic storage device that may store information and computer-readable instructions that may be executed by processor 802. For example, computer-readable storage medium 804 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 804 may be a non-transitory computer-readable medium. In an example, computer-readable storage medium 804 may be remote but accessible to computing device 800.

Computer-readable storage medium 804 may store instructions 806, 808, 810, and 812. Instructions 806 may be executed by processor 802 to extract time-aligned video frames from the video content, each frame representing an image at a different time. Instructions 808 may be executed by processor 802 to extract video content from source media including captured process steps involving a business process performed via an application.

Instructions 810 may be executed by processor 802 to process the time-aligned video frames to extract control data representing the captured process steps related to the business process. Instructions 812 may be executed by processor 802 to generate content in a desired format to perform the business process based on the extracted control data.

Further, non-transitory computer readable storage medium 804 further includes instructions to extract audio content from the source media, generate context information/intent for the audio content based on the time-aligned video frames, convert the audio content into text by using the context information, and generate the content in the desired format based on the extracted control data and the text obtained by converting the audio content.

### Use Case

In Business Process Outsourcing (BPO), the transition process involves transferring business processes or operations from one organization (e.g., a client) to another (e.g., a service provider such as a BPO company). Below is a general outline of how the transition occurs:

### Preparation and Planning

Initial Evaluation and Planning: The client and BPO company collaborate to assess the work scope, requirements, and objectives. This includes pinpointing processes suitable for outsourcing, setting clear goals, and creating a detailed plan with timelines, milestones, resource requirements, risk assessments, and backup plans.

Client SME Involvement: During online meetings, the client's SME demonstrates the processes being outsourced. These sessions are recorded to share the workflows and knowledge with the service provider.

Knowledge Transfer and Training Material Development: To create comprehensive training materials, the service provider converts the recorded sessions into detailed documents outlining the processes, workflows, and Standard Operating Procedures (SOPs). While this approach is valuable, it can be time-consuming.

Challenges of Capturing Tacit Knowledge: Extracting implicit knowledge or “tacit knowledge” shared by the SME during the demonstrations can be difficult solely from recorded videos. This highlights the limitations of relying solely on video recordings for knowledge transfer.

### Video Processing Capability of the Current Subject Matter for Simplified Documentation

Documentation: Examples described herein may streamline video processing, allowing to directly convert recorded videos into structured files ready for editing into documents and simulations. This significantly reduces the time and effort required for documentation creation.

Flexible Output Formats: The processed files can be exported in various formats, including HTML, Microsoft Word, XML, Excel, PDF, BPNM, and Visio. This versatility may ensure compatibility with preferred tools and facilitates presenting and sharing the processed information.

### Simulation

Examples described herein may provide the processed video files that enable the creation of interactive simulations in three modes: Show, Guide, and Test. These modes cater to different learning styles and proficiency levels, allowing users to learn at their own pace. Further, the ability to switch between Show (demonstration), Guide (interactive practice), and Test (assessment) modes may empower users to grasp processes quickly and apply them confidently in real-world scenarios. Additionally, simulations may provide a safe training environment, minimizing the risk of errors or disruptions to real-world data on the production server.

### Types of Data Consumption

Examples described herein may offer a versatile array of output types catering to various needs and preferences. Each document type is designed to serve specific purposes, with distinct templates available.
Standard Operating Procedures (SOPs): An SOP may refer to a document that outlines step-by-step instructions on how to perform a particular task or activity within an organization. SOPs are crucial for ensuring consistency, quality, and efficiency in various processes.
Business Requirements Documents (BRD): A BRD may be a comprehensive outline or blueprint that captures the requirements and expectations for a project or system from a business perspective.
Procedural Manual: The procedural manual may serve as a comprehensive guide for employees, outlining the specific steps and protocols to follow when carrying out various tasks or processes. It is valuable for maintaining consistency, quality, efficiency, and compliance across different areas of an organization.
Data Entry Format: This document may outline the creation of an intuitive and user-friendly data entry format. This format should ensure the accurate capture of all information necessary for analysis or processing.
Cue Card: Cue cards may provide a quick reference guide for process flows. They include step-by-step descriptions without images, allowing users to focus on the essential actions.
Testing Guide: The testing guide may serve as a comprehensive reference for testing teams, ensuring that the teams follow a structured approach to testing, covering several types, methodologies, and best practices for ensuring product quality.

Further, the system offers flexibility in publishing documents, allowing users to choose between individual documents or consolidated screens. This empowers users to tailor the information presentation to their specific needs, whether a focused single document or a comprehensive compilation. A variety of output formats are available, including HTML, Microsoft Word, PowerPoint, XML, Excel, PDF, BPNM, and Visio as follows:
HTML: This format may allow for web-based viewing, often used for online publishing due to its compatibility with browsers.
Microsoft Word: A widely used word processing format that is versatile for creating various documents.
PowerPoint Presentation: Ideal for creating presentations with slides, graphics, and multimedia elements for a visually engaging display.
XML (Extensible Markup Language): Offers structured data storage and interchange between different systems. In this context, it is used for interactive simulations.
Microsoft Excel: Known for spreadsheets, suitable for organizing and analyzing data in a tabular format.
PDF (Portable Document Format): A widely used format for sharing documents, ensuring they look the same regardless of the device or software used to view them.
BPMN (Business Process Model and Notation): Used for modelling business processes, representing workflows and interactions between elements.
Visio: A diagramming tool often used for creating flowcharts, diagrams, and visual representations.

Furthermore, examples described herein may allow users to create interactive simulations. These simulations offer three distinct modes to cater to different learning styles:
Show Mode: Users can observe the process unfold like a video, gaining a clear understanding of the step-by-step sequence.
Guide Mode: This mode fosters a guided learning experience. Users can interact with the simulation, seek hints when needed, or prompt the system to perform specific actions for a more hands-on approach.
Test Mode: Users can assess their grasp of the process through interactive quizzes or challenges within the simulation, allowing them to gauge their understanding.

Also, examples described herein may leverage a multi-mode XML format to cater to various learning styles. It offers interactive features like Show, Guide, and Test modes, allowing users to engage with complex processes in a dynamic and immersive way. Additionally, the ability to publish documents as individual screens or consolidated reports provides flexibility for users to tailor information presentation based on user preferences or specific use cases.

Thus, examples described herein may provide a rich set of output formats and interactive features. Users can personalize information delivery to suit their needs and preferences, fostering effective communication and comprehension.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A computer-implemented method comprising:
extracting video content from source media including captured process steps involving a business process performed via an application;
extracting time-aligned video frames from the video content, each frame representing an image at a different time;
processing the time-aligned video frames to extract control data representing the captured process steps related to the business process; and
generating content in a desired format to perform the business process based on the extracted control data.

2. The computer-implemented method of claim 1, further comprising:
extracting audio content from the source media;
generating context information/intent for the audio content based on the time-aligned video frames;
converting the audio content into text by using the context information; and
generating the content in the desired format based on the extracted control data and the text obtained by converting the audio content.

3. The computer-implemented method of claim 1, wherein processing the time-aligned video frames comprises:
generating respective optical character recognition (OCR) data associated with the time-aligned video frames; and
extracting, based at least in part on the respective OCR data, the control data representing the captured process steps associated with the time-aligned video frames.

4. The computer-implemented method of claim 1, wherein processing the time-aligned video frames comprises:
analyzing successive frames of the time-aligned video frames to extract the control data, wherein analyzing the successive frames comprises:
for each frame,
detecting a change in a current frame relative to a previous frame;
determining coordinates corresponding to the detected change in the current frame; and
extracting the control data from the current frame based on the determined coordinates.

5. The computer-implemented method of claim 1, wherein processing the time-aligned video frames comprises:
for each frame of the time-aligned video frames,
identifying a position of a mouse cursor indicating a current point of user interaction within a current frame of the time-aligned video frames;
determining coordinates corresponding to the position of the mouse cursor in the current frame; and
extracting the control data from the current frame based on the determined coordinates.

6. The computer-implemented method of claim 1, wherein processing the time-aligned video frames comprises:
for each frame of the time-aligned video frames,
identifying a caret position indicating a text insertion point within a current frame of the time-aligned video frames;
determining coordinates corresponding to the caret position in the current frame; and
extracting the control data from the current frame based on the determined coordinates.

7. The computer-implemented method of claim 1, wherein processing the time-aligned video frames comprises:
for each frame of the time-aligned video frames,
detecting a border of a graphical user interface (GUI) element within a current frame of the time-aligned video frames;
determining coordinates corresponding to the GUI element in the current frame based on the detected border; and
extracting the control data from the current frame based on the determined coordinates.

8. The computer-implemented method of claim 1, wherein processing the time-aligned video frames comprises:
removing redundant frames that are identical or similar from the time-aligned video frames;
upon removing the redundant frames, performing at least one of:
filtering the time-aligned video frames to remove unwanted data from the time-aligned video frames;
refining the time-aligned video frames to enhance quality of information within the time-aligned video frames;
fusing the time-aligned video frames to leverage data from different frames to enhance the quality of information; and
normalizing the time-aligned video frames to scale pixel values within each frame of the time-aligned video frames to a specific range.

9. The computer-implemented method of claim 1, wherein processing the time-aligned video frames comprises:
processing the time-aligned video frames using a trained machine learning model to extract the control data representing the captured process steps related to the business process.

10. The computer-implemented method of claim 1, wherein the time-aligned video frames are extracted from the video content at a specific frame rate.

11. The computer-implemented method of claim 1, further comprising:
creating a simulated business process to perform the process steps involving the business process based on the generated content, wherein the simulated business process comprises at least one of:
a show mode to demonstrate the simulation without user interaction;
a guide mode to provide a step-by-step guidance as a user interacts with the simulated business process; and
a test mode to assess the user's understanding or proficiency with the simulated business process.

12. A system comprising:
a processor; and
a memory communicatively coupled to the processor, wherein the memory comprises a content generation module to:
extract video content from source media including captured process steps involving a business process performed via an application;
extract time-aligned video frames from the video content, each frame representing an image at a different time;
process the time-aligned video frames to extract control data representing the captured process steps related to the business process; and
generate content in a desired format to perform the business process based on the extracted control data.

13. The system of claim 12, wherein the content generation module is to:
extract audio content from the source media;
generate context information/intent for the audio content based on the time-aligned video frames;
convert the audio content into text by using the context information; and
generate the content in the desired format based on the extracted control data and the text obtained by converting the audio content.

14. The system of claim 12, wherein the content generation module is to:
analyze successive frames of the time-aligned video frames to extract the control data, wherein analyzing the successive frames comprises:
for each frame,
detecting a change in a current frame relative to a previous frame;
determining coordinates corresponding to the detected change in the current frame; and
extracting the control data from the current frame based on the determined coordinates.

15. The system of claim 12, wherein the content generation module is to:
for each frame of the time-aligned video frames,
identify a position of a mouse cursor indicating a current point of user interaction within a current frame of the time-aligned video frames;
determine coordinates corresponding to the position of the mouse cursor in the current frame; and
extract the control data from the current frame based on the determined coordinates.

16. The system of claim 12, wherein the content generation module is to:
for each frame of the time-aligned video frames,
identify a caret position indicating a text insertion point within a current frame of the time-aligned video frames;
determine coordinates corresponding to the caret position in the current frame; and
extract the control data from the current frame based on the determined coordinates.

17. The system of claim 12, wherein the content generation module is to:
for each frame of the time-aligned video frames,
detect a border of a graphical user interface (GUI) element within a current frame of the time-aligned video frames;
determine coordinates corresponding to the GUI element in the current frame based on the detected border; and
extract the control data from the current frame based on the determined coordinates.

18. The system of claim 12, wherein the content generation module is to:
create a simulated business process to perform the process steps involving the business process based on the generated content, wherein the simulated business process comprises at least one of:
a show mode to demonstrate the simulation without user interaction;
a guide mode to provide a step-by-step guidance as a user interacts with the simulated business process; and
a test mode to assess the user's understanding or proficiency with the simulated business process.

19. A non-transitory computer readable storage medium comprising instructions executable by a processor of a computing device to:
a processor; and
a memory communicatively coupled to the processor, wherein the memory comprises a content generation module to:
extract video content from source media including captured process steps involving a business process performed via an application;
extract time-aligned video frames from the video content, each frame representing an image at a different time;
process the time-aligned video frames to extract control data representing the captured process steps related to the business process; and
generate content in a desired format to perform the business process based on the extracted control data.

20. The non-transitory computer readable storage medium of claim 19, further comprising instructions to:
extract audio content from the source media;
generate context information/intent for the audio content based on the time-aligned video frames;
convert the audio content into text by using the context information; and
generate the content in the desired format based on the extracted control data and the text obtained by converting the audio content.

21. The non-transitory computer readable storage medium of claim 19, wherein instructions to process the time-aligned video frames comprise instructions to:
process the time-aligned video frames using a trained machine learning model to extract the control data representing the captured process steps related to the business process.

22. The non-transitory computer readable storage medium of claim 19, further comprising instructions to:
create a simulated business process to perform the process steps involving the business process based on the generated content, wherein the simulated business process comprises at least one of:
a show mode to demonstrate the simulation without user interaction;
a guide mode to provide a step-by-step guidance as a user interacts with the simulated business process; and
a test mode to assess the user's understanding or proficiency with the simulated business process.
